(19) United States
(12) Patent Application Publication
(10) Pub. No.: US 2006/0242909 A1
(43) Pub. Date: Nov. 2, 2006

(54) Drive mechanism for the actuation of an opening frame

(76) Inventor: Laurent Arquevaux, Sully Sur Loire (FR)

Correspondence Address: CARLSON, GASKEY & OLDS, P.C., 400 WEST MAPLE ROAD, SUITE 350, BIRMINGHAM, MI, 48009, US

(21) Appl. No.: 11/413,132

(22) Filed: Apr. 27, 2006

(30) Foreign Application Priority Data
Apr. 28, 2005 (FR) 05 04 291

(51) Int. Cl. E05F 15/02; F16D 13/04

(52) U.S. Cl. 49/340; 192/35

(57) ABSTRACT

A drive mechanism for actuating an opening frame includes a toothed crown and a toothed wheel engaging at least one section of the toothed crown. The drive mechanism also includes an arm driving the toothed wheel on the toothed crown, a pinion designed to be driven in rotation around an axis and that is engaged with one end of the arm, and a cable for actuating the opening frame that is attached to the toothed wheel. A low-power motor can be used to open and close the opening frame electrically.

### REFERENCE TO RELATED APPLICATION

This application claims priority to French Patent Application FR 05 04 291 filed on Apr. 28, 2005.

### TECHNICAL FIELD

This invention relates generally to a drive mechanism for the actuation of an opening frame. In particular, this mechanism is designed to be installed in a motor vehicle to allow for a vehicle hatchback to be opened and closed.

### BACKGROUND OF THE INVENTION

Conventionally, a vehicle hatchback is articulated to a vehicle body at a rear of a vehicle by hinges. The hatchback is actuated around an axis of the hinges with two cylinders, one located on either side of the hatchback. Each cylinder includes a chamber attached to the vehicle body in which a piston is positioned. The piston is attached to an end of a rod and slides in the chamber. The other end of the rod is attached to the hatchback.

In a conventional non-motorized hatchback, a line of thrust of each cylinder, corresponding to a longitudinal axis of the cylinder, forms an angle of just a few degrees with a plane including the hinges and fixation points of the cylinders to the hatchback when the hatchback is closed. When a user opens a hatchback lock, traction must be exerted on the hatchback in order to open it. When the hatchback has been opened to a certain position, it then continues to open under the thrust of the cylinders alone.

A motorized self-opening hatchback is known, in particular on the vehicle of trademark Vectra made by Opel. Two gas cylinders allow for the hatchback to be actuated. One end of a pull cable longitudinal to the cylinder is attached to the cylinder, and the other end of the pull cable is attached to a motorized system attached to the vehicle body. The motorized system is a cylindrical drum driven in rotation by a wheel and pinion reduction system, which is driven in rotation by a motor. In normal operation, the user presses a button to control automatic opening or closing of the hatchback. When the hatchback is closed, the line of thrust of the cylinders forms a relatively wide angle with respect to the plane including the hinges coupling the hatchback to the vehicle body and the points of fixation of the cylinders on the hatchback. Thus, when the hatchback is no longer maintained in the closed position, it opens under the thrust of the cylinders alone. User actuation of the hatchback closure control button triggers traction on the pull cables by the motorized systems, leading to the compression of the cylinders. One drawback of this motorized self-opening hatchback is that the motorized system for these cylinders supplies a constant load to the cable. However, the load actually required to open and close an opening frame is not constant throughout the travel of the opening frame. This motorized system thus supplies, throughout the entire travel of the hatchback, a load that is at least equal to the maximum load actually required at any given moment. Thus, the motor of the motorized system is set to the greatest load that it must overcome when the hatchback is moving.

The invention provides a drive mechanism for motorized actuation of an opening frame, allowing for the use of a low-power and compact motor.

### SUMMARY OF THE INVENTION

A drive mechanism for actuating an opening frame includes a toothed crown, a toothed wheel that engages at least one section of the toothed crown and an arm driving the toothed wheel on the toothed crown. The drive mechanism also includes a pinion designed to be driven in rotation around an axis and that is engaged with one end of the arm, and a cable for actuating the opening frame that is attached to the toothed wheel.

According to another feature, the toothed wheel is mounted to rotate freely on one end of the arm. According to another feature, a radius of the toothed crown is substantially equal to a diameter of the toothed wheel. According to another feature, the pinion is driven in rotation by a motor. According to another feature, the drive mechanism also includes an electronic control system associated with the motor. The electronic control system is provided with an anti-squeeze feature and/or an anti-collision function for the movements of the opening frame. According to another feature, the pinion is driven in rotation by a series of gears. According to another feature, the cable for actuating the opening frame is a push-pull cable. According to another feature, the cable is attached to the toothed wheel by a pivot connection. According to another feature, the cable is attached to the toothed wheel near the edge of the toothed wheel. A motor vehicle includes a body, an opening frame, and a drive mechanism as described above that is attached to the body or to the opening frame.

### BRIEF DESCRIPTION OF THE DRAWINGS

Other characteristics and advantages of the invention will become apparent on reading the following detailed description of the embodiments of the invention given as an example only and with reference to the drawings, which show:

FIG. 1 schematically illustrates a perspective view of a drive mechanism according to the invention in a first position;

FIG. 2 schematically illustrates a perspective view of the drive mechanism according to the invention in a second position;

FIG. 3 schematically illustrates a perspective view of the drive mechanism according to the invention in a third position;

FIG. 4 schematically illustrates a pivot connection between a cable and a toothed wheel;

FIG. 5 schematically illustrates a curve representing displacement of the cable as a function of an angle of rotation of an arm; and

FIG. 6 schematically illustrates a curve representing effort applied to the cable as a function of the angle of rotation of the arm.

### DETAILED DESCRIPTION OF THE INVENTION

A drive mechanism for actuating an opening frame according to the invention includes a toothed crown, a toothed wheel engaging with at least one section of the toothed crown and an arm driving the toothed wheel on the toothed crown. The drive mechanism also includes a pinion designed to be driven in rotation around an axis and that is engaged with one end of the arm, and a cable for actuating the opening frame. The cable is attached to the toothed wheel. The engagement of the toothed wheel with the toothed crown allows for a point of fixation of the cable to the toothed wheel to run on a line segment that corresponds, for example, to a stroke of a cylinder allowing for the opening frame to be actuated. In addition, the engagement of the arm with the rotating pinion, the toothed wheel being mounted on the arm, allows for a speed of the point of fixation of the cable to the toothed wheel to be varied during its travel along the line segment. Thus, a load adapted in relation to the position of the opening frame is applied to the cable. The variation of the speed of the point of fixation of the cable thus allows for a low-power motor to be used. Moreover, the use of the low-power motor reduces the space occupied in a trunk.

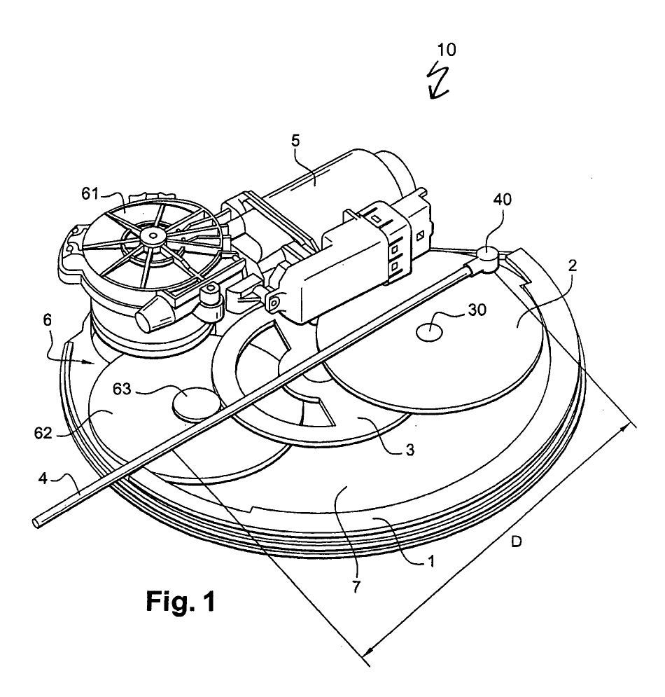

FIGS. 1 to 3 show a perspective view of the drive mechanism according to the invention in three different positions, respectively. Identical references on the different figures represent identical or similar components.

A drive mechanism 10 according to this invention includes a toothed crown 1 fixedly mounted on a plate 7. The drive mechanism 10 also includes a toothed wheel 2 that engages with the toothed crown 1. Preferably, in order to reduce bulk, the toothed wheel 2 engages with an interior of the toothed crown 1. The radius of the toothed crown 1 is substantially equal to a diameter of the toothed wheel 2.

As shown in particular in FIGS. 1 to 3, the toothed crown 1 is replaced by a toothed half crown. For the purposes of the invention, the toothed wheel 2 only moves over a portion of the interior of the toothed crown 1 that is slightly less than a half crown. To reduce the bulk of the drive mechanism 10, it is therefore advantageous that the toothed crown 1 includes a half crown only. However, the word “crown” will be used in the remainder of the description, as this term is non limitative.

Additionally, the drive mechanism 10 includes a cable 4 with one end attached to the toothed wheel 2. The point of fixation of the cable 4 to the toothed wheel 2 is preferably located near an edge of the toothed wheel 2. Moreover, the direction of the cable 4 is substantially parallel to a surface of the toothed wheel 2. The other end of the cable 4 is designed to be attached to a device for actuating an opening frame, for example a cylinder. The opening frame can be a vehicle door, a tailgate (a hatchback) or a sunroof.

Because the radius of the toothed crown 1 is substantially equal to the diameter of the toothed wheel 2, the fixation point of the cable 4 to the toothed wheel 2 substantially describes a line segment during the opening or closing of the opening frame. The driving of the cable 4 by the drive mechanism 10 allows for the opening frame to be actuated, in particular a motor vehicle opening frame.

This cable 4 is, for example, a pull cable only. In this case, the drive mechanism 10 pulls the cable 4 to close the opening frame only. Opening is then carried out under the thrust of the opening frame actuation devices alone. It is also possible that during the opening of the opening frame, the motor of the drive mechanism 10 operates to control the opening speed of the opening frame to maintain a constant opening frame opening speed. Without this, the opening frame opens slowly at first and then quickly, which may take an unsuspecting user by surprise and is not conducive to safety. The advantages of the drive mechanism 10 equipped with a pull cable only are thus limited to those described above, i.e., the use of a low-power motor made possible by the speed variation of the point of fixation of the cable 4 to the toothed wheel 2. The load applied to the cable 4 by the drive mechanism 10 is thus variable and applied at a variable speed, which allows for the motor power to be set more accurately.

Preferably, the cable 4 is a push-pull cable. A push-pull cable is designed to resist the pulling or compression pressure, allowing for the opening frame to be opened or closed, for example a vehicle hatchback. The push-pull cable is, for example, the type of cable used in window regulators to drive the sliders supporting the window. The use of a push-pull cable allows for a variable load to be applied at a variable speed, not only on closing as in the case of a pull cable alone, but also on opening, as the push-pull cable is designed to be both compressed and pulled. The drive mechanism 10 according to the invention equipped with a push-pull cable therefore offers the advantage of being able to use a low-power motor for opening as well.

The use of a push-pull cable provides the drive mechanism 10 with numerous additional advantages compared with the use of a pull cable alone. In particular, it is possible for a user to open and close the opening frame manually without exerting much effort.

Indeed, one drawback of the cylinders of the prior art described above is that, when a user wishes to close the hatchback manually, he must provide a large amount of effort throughout the closure of the hatchback in order to close it successfully. The effort required, in particular as the hatchback approaches its closed position, is greater than the effort required with a non-motorized hatchback to overcome the thrust of the cylinders which are designed to open the hatchback under their thrust alone.

As a push-pull cable is very resistant, it can exert a large effort on the opening frame when the opening frame is opened. It is then possible to position the actuation device(s) substantially as for a conventional non-motorized hatchback, i.e., with a line of thrust forming a very narrow angle with the plane including the hinges and the points of fixation of the cylinders to the hatchback when it is closed. In this configuration, the effort exerted by the push-pull cable to open the opening frame replaces the effort exerted manually on a non-motorized hatchback, in particular at the beginning of the opening of the opening frame, as the thrust of the cylinder alone does not allow for the opening frame to be opened even when the lock on the opening frame is open. As a result of a configuration close to that of a non-motorized hatchback, a user may close the opening frame manually without exerting much effort on the latter, in particular as the opening frame approaches the closed position.

In addition, as the fixation point of the push-pull cable to the toothed wheel 2 travels along a line segment, the mechanism ensures that the cable 4 compression takes place correctly and parallel to the axis of the opening frame actuation device, which allows for the energy efficiency of the actuation device to be optimized.

The drive mechanism 10 also includes an arm 3 driving the toothed wheel 2 along the toothed crown 1, a pinion 63 driving the arm 3, and a motor 5. The toothed wheel 2 is mounted to rotate freely by a shaft 30 at one end of the arm 3. The other end of the arm 3 engages with the pinion 63. The pinion 63 is designed to be rotated, preferably by the motor 5. The pinion 63 can be directly linked to the motor 5.

The pinion 63 is linked to the motor 5 by a series of gears 6 that allows for a low-power motor 5 to be used, which also reduces the bulk of the drive mechanism 10. The series of gears 6 includes, for example, a drive pinion 61 directly connected to the motor 5 which engages a second toothed wheel 62 on which the pinion 63 that drives the arm 3 is fixedly mounted. The second toothed wheel 62 and the pinion 63 that drives the arm 3 are mounted rotating freely on a shaft (not shown) attached to the plate 7 of the drive mechanism 10. In this embodiment, the motor 5 is, for example, a motor used in window regulators.

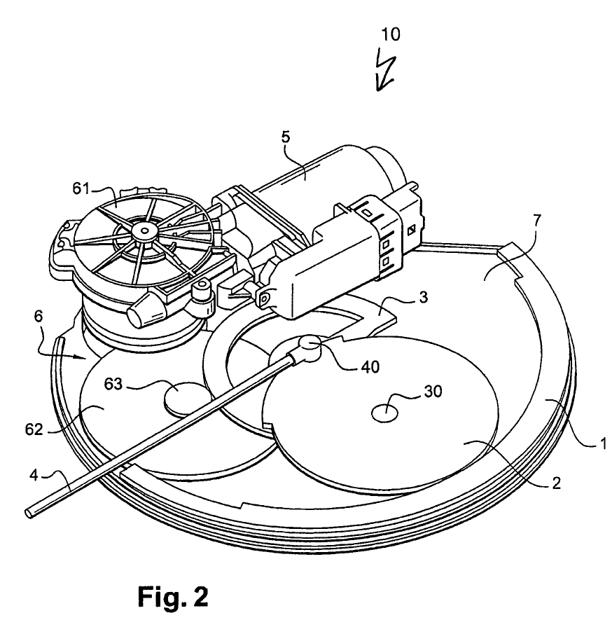

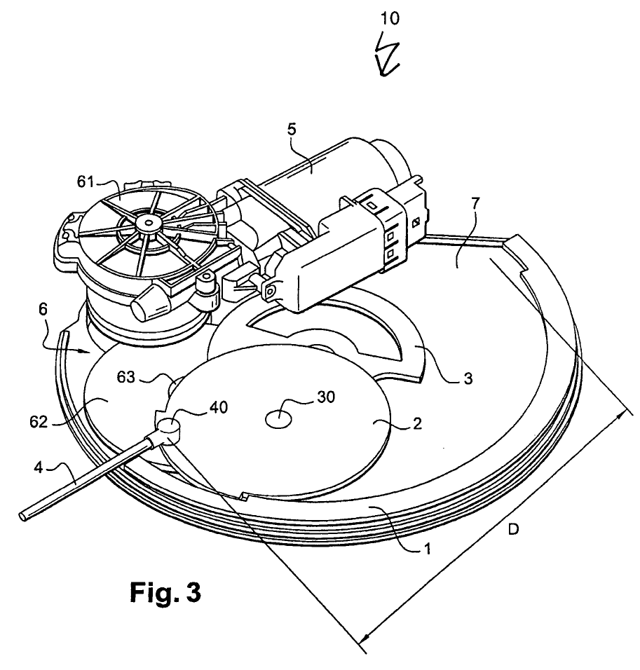

Under the action of the motor 5, the pinion 63 drives the arm 3 in rotation, which itself drives the toothed wheel 2 in rotation. The toothed wheel 2 then moves along the toothed crown 1 between two extreme positions. These two extreme positions correspond to a closed position and an open position of the opening frame, shown respectively in FIGS. 1 and 3. FIG. 2 shows an intermediate position of the toothed wheel 2, corresponding to an intermediate position of the opening frame located between the open position and the closed position. If the drive mechanism 10 is equipped with a pull cable only, the toothed wheel 2 moves from the open position to the closed position under the action of the motor 5 and from the closed position to the open position under the action of the opening frame actuation device. However, if the drive mechanism 10 is equipped with a push-pull cable, the toothed wheel 2 moves from the open position to the closed position and from the closed position to the open position under the action of the motor 5, as the cable 4 can be pulled as well as compressed.

The cable 4 is attached to the toothed wheel 2 by a pivot connection 20. The pivot connection 20 prevents the cable 4 from twisting on rotation of the toothed wheel 2 and ensures that the cable 4 as a whole is kept parallel to the line segment described by the point of fixation of the cable 4 to the toothed wheel 2, such that in particular when the cable 4 is a push-pull cable, the thrust of the cable 4 is exerted along the axis of the cable 4.

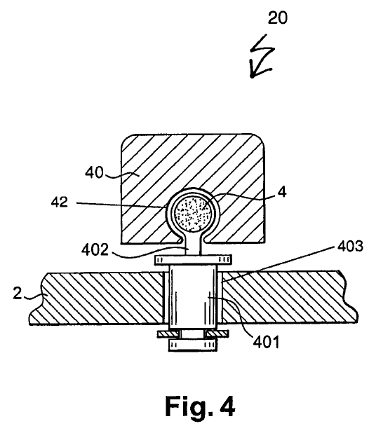

FIG. 4 shows a non-limitative example of a pivot connection 20 between the cable 4 and the toothed wheel 2. In this embodiment, the pivot connection 20 includes a cylindrical member 401 cooperating with a recess 403 in the toothed wheel 2 that is a complementary shape to the cylindrical member 401. The pivot connection 20 also includes a projection 402 swaged to the end of the cable 4. The cable 4 is substantially parallel to the toothed wheel 2. The projection 402 maintaining the cable 4 is located in an aperture 42 of an element 40. The element 40 guides the end of cable 4, attached to the toothed wheel 2 by the pivot connection 20, to direct the cable 4 in a direction parallel to the line segment described by the fixation point of the cable 4 on the toothed wheel 2.

In addition, the cable 4 is inserted into a sheath (not shown) from the pivot connection 20 to the opening frame actuation device to prevent the cable 4 from twisting or bending, in particular when it is under compression (in the case of a push-pull cable).

The cable 4 is preferably attached close to the edge of the toothed wheel 2. In addition, the fixation point of the cable 4 to the toothed wheel 2 is preferably situated close to the toothed crown 1 in the two extreme positions, as shown in particular in FIGS. 1 and 3. The cable 4 describes a course D between these two positions.

In the case of a push-pull cable, when the drive mechanism 10 moves from the position shown in FIG. 1 (opening frame closed position) to the position shown in FIG. 3 (opening frame open position), the cable 4 is compressed. Conversely, when the drive mechanism 10 moves from the position shown in FIG. 3 (opening frame open position) to the position shown in FIG. 1 (opening frame closed position), the cable 4 is pulled. It is therefore advantageous to have a push-pull cable that can withstand both types of stress.

In the case of a pull cable only, the motor 5 is disengaged when the opening frame is opened, or is engaged and acts as a brake, with the opening being performed under the thrust action of the cylinders alone.

Due to the presence of the arm 3 between the pinion 63 and the toothed wheel 2, the load exerted on the cable 4 by the drive mechanism 10 varies over the duration of the course D of the cable 4.

FIG. 5 shows a curve representing the displacement of the point of fixation of the cable 4 to the toothed wheel 2 as a function of a angle of rotation of the arm 3 relative to the line segment described by the point of fixation of the cable 4 to the toothed wheel 2 during the opening or closing of the opening frame. This displacement is a section of a sinusoidal curve. Points O₁ and F₁ correspond to the angles of rotation of the arm 3 in the open position and the closed positions of the opening frame, respectively.

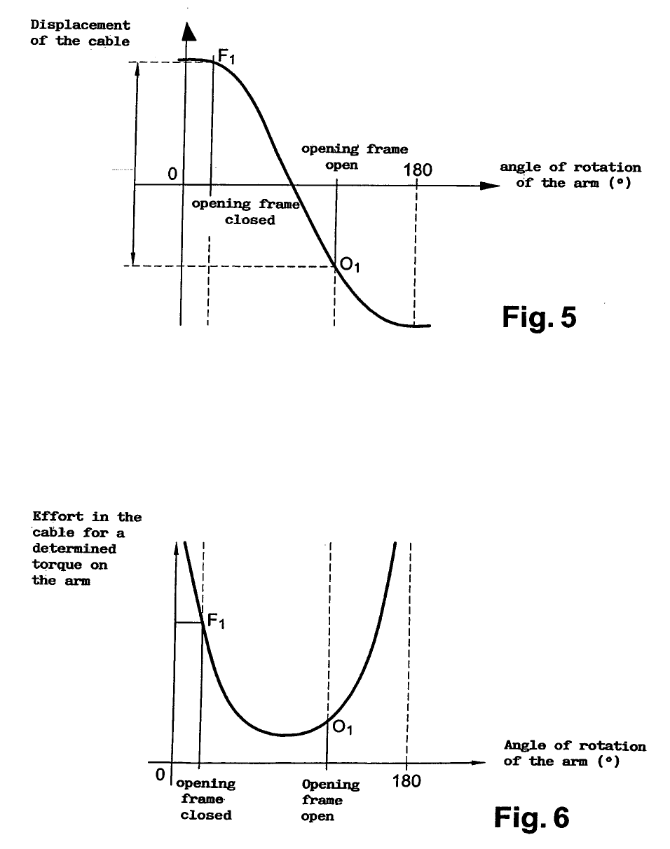

FIG. 6 shows a curve representing the effort applied to the cable 4 as a function of the angle of rotation of the arm 3. This effort is a section of an inverse sine curve. On average, it increases during closing and decreases during opening (in the case of a push-pull cable) to adapt to the necessary requirements for countering or working with the thrust of the actuation device respectively.

Unless otherwise stated, the remainder of the description concerns the drive mechanism 10 equipped with a push-pull cable. To move from the closed position to the open position of the opening frame, a large load must be applied at the start, reducing proportionally to the movement of the cable 4 by the drive mechanism 10. Indeed, when the opening frame is in the closed position, each hinge and the fixation points of the actuation device are almost aligned. As explained above, the use of a push-pull cable allows for the actuator device(s) to be positioned as in a conventional non-motorized hatchback. A large load is therefore required to open the opening frame. In contrast, the load necessary reduces when the line of thrust of the actuator device varies during the opening of the opening frame.

To move from the open position to the closed position of the opening frame, a moderate load is required at the start, increasing proportionally to the movement of the cable 4 by the drive mechanism 10.

The drive mechanism 10 according to the invention thus allows for a variable load to be applied to the cable 4, using a relatively low-power motor. In particular, during opening, the drive mechanism 10 allows for a large load to be applied to the cable 4 at the start of opening of the opening frame as the speed of the cable is low, then for a much smaller load to be applied to the cable 4 at the end of the opening of the opening frame as the speed of the cable 4 is then much quicker. Thus, the motor 5 power is more accurately set. In addition, this speed variation allows for the opening frame to be opened at a constant speed. In contrast, in the motorized self-opening hatchback of the prior art described above, the hatchback opens very slowly at first and then very fast at the end of its stroke. An unsuspecting user may then be taken by surprise. The drive mechanism 10 according to the invention is therefore safer.

When the motor 5 is not operating, it is disengaged. When a user of the vehicle on which the drive mechanism 10 is installed activates an actuation member, for example a control button or lever, the motor 5 is engaged and started up. The vehicle may be equipped with two control members, one for opening and another for closing. The control device may be located near to the vehicle dashboard or close to the opening frame or in any other location on the vehicle. In one variant, the actuation member is a remote control designed to transmit an open or close signal to the opening frame actuation device.

When the opening frame is opened or closed manually with the drive mechanism 10 motor disengaged, the effort provided by the user to open or close the opening frame will be similar to the effort required to open or close a non-motorized opening frame, in particular due to the presence of the push-pull cable. This allows for the opening frame actuation device to be located in a similar position to that on a non-motorized opening frame.

In manual opening or closing, the motor 5 is disengaged. The push-pull cable connected to the opening frame therefore drives the drive mechanism 10 according to the invention towards the open position or the closed position, respectively, under the manual operation of the opening frame by the user.

For a drive mechanism 10 equipped with a pull cable only, the automatic opening and closing of the opening frame can also be controlled by a button, lever or remote control actuation device. In manual opening or closing, the motor 5 is disengaged. In manual opening, the opening frame pulls the pull cable, which in turn drives the drive mechanism 10 according to the invention towards the open position. In manual closing, a torsion spring (not shown) winds the cable 4 even when the motor 5 is disengaged, ensuring that the cable 4 is kept under slight tension.

The drive mechanism 10 according to the invention may be associated with an electronic control system provided with an anti-squeeze function or an anti-collision function for the movements of the opening frame. This function may include a conventional algorithm consisting of measuring the parameters of the motor, in particular the current passing through the motor and the angle position of the rotor shaft of the motor. For example, when the current value combined with a motor position exceeds a pre-determined threshold value, the electronic control system interprets this as the presence of an obstacle in the path of the opening frame and orders the stopping, or even the reversal of the direction of rotation, of the motor 5. This function may include devices of detection known in the art, such as sensor seals around the circumference of the opening frame, non-contact optical devices, or combinations of these devices.

The invention also relates to a motor vehicle including a body, an opening frame and at least one drive mechanism 10 described above. The drive mechanism 10 is mounted either on the body of the vehicle or on the opening frame. It is designed to be used jointly with an opening frame actuation device, for example a cylinder.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A drive mechanism for actuating an opening frame, the drive mechanism comprising:
a toothed crown;
a toothed wheel engaging at least one section of the toothed crown;
an arm driving the toothed wheel on the toothed crown, wherein the arm includes an end;
a pinion to be driven in rotation around an axis, wherein the end of the arm engages the pinion; and
a cable for actuating the opening frame, wherein the cable is attached to the toothed wheel.

2. The drive mechanism according to claim 1, wherein the arm includes another end, and the toothed wheel is mounted to rotate freely on the another end of the arm.

3. The drive mechanism according to claim 1, wherein the toothed crown has a radius and the toothed wheel has a diameter, and the radius of the toothed crown is substantially equal to the diameter of the toothed wheel.

4. The drive mechanism according to claim 1, further including a motor, wherein the pinion is driven in rotation by the motor.

5. The drive mechanism according to claim 4, further including an electronic control system associated with the motor, wherein the electronic control system provides at least one of an anti-squeeze function and an anti-collision function during movement of the opening frame.

6. The drive mechanism according to claim 1, further including a series of gears, wherein the pinion is driven in rotation by the series of gears.

7. The drive mechanism according to claim 1, wherein the cable is a push-pull cable.

8. The drive mechanism according to claim 1, wherein the cable is a pull cable.

9. The drive mechanism according to claim 1, wherein the cable is attached to the toothed wheel by a pivot connection.

10. The drive mechanism according to claim 1, wherein the toothed wheel includes an edge, and the cable is attached to the toothed wheel near the edge of the toothed wheel.

11. A motor vehicle comprising:
a body;
an opening frame; and
a drive mechanism for actuating the opening frame, the drive mechanism including:
a toothed crown,
a toothed wheel engaging at least one section of the toothed crown,
an arm driving the toothed wheel on the toothed crown, wherein the arm includes an end,
a pinion to be driven in rotation around an axis, wherein the end of the arm engages the pinion, and
a cable for actuating the opening frame, wherein the cable is attached to the toothed wheel, wherein the drive mechanism is attached to one of the body and the opening frame.

12. The motor vehicle according to claim 11, wherein the arm includes another end, and the toothed wheel is mounted to rotate freely on the another end of the arm.

13. The motor vehicle according to claim 11, wherein the toothed crown has a radius and the toothed wheel has a diameter, and the radius of the toothed crown is substantially equal to the diameter of the toothed wheel.

14. The motor vehicle according to claim 11, further including a motor, wherein the pinion is driven in rotation by the motor.

15. The motor vehicle according to claim 14, further including an electronic control system associated with the motor, wherein the electronic control system provides at least one of an anti-squeeze function and an anti-collision function during movement of the opening frame.

16. The motor vehicle according to claim 11, further including a series of gears, wherein the pinion is driven in rotation by the series of gears.

17. The motor vehicle according to claim 11, wherein the cable a push-pull cable.

18. The motor vehicle according to claim 11, wherein the cable is a pull cable.

19. The motor vehicle according to claim 11, wherein the cable is attached to the toothed wheel by a pivot connection.

20. The motor vehicle according to claim 11, wherein the toothed wheel includes and edge, and the cable is attached to the toothed wheel near the edge of the toothed wheel.
